(19) United States
(12) Patent Application Publication
(10) Pub. No.: US 2023/0081903 A1
(43) Pub. Date: Mar. 16, 2023

(54) Quantum State Preparation Circuit Generation Method and Apparatus, Chip, Device, and Program Product

(71) Applicant: Tencent Technology (Shenzhen) Company Limited, Shenzhen (CN)

(72) Inventors: Pei YUAN, Shenzhen (CN); Shuai YANG, Shenzhen (CN); Guojing TIAN, Shenzhen (CN); Xiaoming SUN, Shenzhen (CN); Shengyu ZHANG, Shenzhen (CN)

(73) Assignee: Tencent Technology (Shenzhen) Company Limited, Shenzhen (CN)

(21) Appl. No.: 18/054,724

(22) Filed: Nov. 11, 2022

Related U.S. Application Data
(63) Continuation of application No. PCT/CN2021/126485, filed on Oct. 26, 2021.

(30) Foreign Application Priority Data
Aug. 2, 2021 (CN) 202110879983.0

(51) Int. Cl. G06N 10/20

(52) U.S. Cl. CPC G06N 10/20

(57) ABSTRACT

A quantum state preparation circuit generation method and apparatus, a chip, a device, and a program product are provided, which relate to the field of quantum technology. The quantum state preparation circuit generation method includes: obtaining a target vector (21); generating a quantum state intermediate preparation circuit (22) for preparing the target vector on N qubits, the quantum state intermediate preparation circuit including N qubit uniform control gates, and N being a positive integer greater than or equal to 2; and converting each of the N qubit uniform control gates into a diagonal unitary matrix and a single bit gate, to obtain a quantum state preparation circuit (23) for preparing the target vector on the N qubits. This application can reduce a depth of a quantum state preparation circuit.

### RELATED APPLICATION

This application is a continuation of and claims the benefit of priority to International PCT Patent Application No. PCT/CN2021/126485 filed on Oct. 26, 2021, which claims priority to Chinese Patent Application 202110879983.0, filed on Aug. 2, 2021, both entitled “QUANTUM STATE PREPARATION CIRCUIT GENERATION METHOD AND APPARATUS, QUANTUM OPERATION CHIP, AND DEVICE”, which is incorporated herein by reference in its entirety.

### FIELD OF THE TECHNOLOGY

Embodiments of this application relate to the field of quantum technology, and in particular, to a quantum state preparation circuit generation method and apparatus, a chip, a device, and a program product.

### BACKGROUND OF THE DISCLOSURE

Quantum state preparation refers to a process of loading classical information into a quantum computing device.

The physical implementation of a quantum system decoheres. That is, the coherence of the quantum system gradually disappears over time, and the quantum system eventually degenerates into a classical system. To prevent decoherence, a quantum circuit needs to be designed with as short execution time as possible.

Currently, a circuit depth of a quantum state preparation circuit that has been implemented is O(2^{N}), where N is a quantity or number of qubits. For the quantum system, a depth of the quantum state preparation circuit still has a relatively large room for improvement.

### SUMMARY

Embodiments of this application provide a quantum state preparation method and apparatus, a chip, a device, and a program product, which can construct a quantum state preparation circuit with a circuit depth close to a lower bound of a theoretical depth. The technical solutions are as follows:

According to an aspect of the embodiments of this application, a quantum state preparation circuit generation method is provided, including:

obtaining a target vector;

generating a quantum state intermediate preparation circuit for preparing the target vector on N qubits, the quantum state intermediate preparation circuit including N qubit uniform control gates, and N being a positive integer greater than or equal to 2; and

respectively converting each of the N qubit uniform control gates into a diagonal unitary matrix and a single bit gate, to obtain a quantum state preparation circuit for preparing the target vector on the N qubits,

the diagonal unitary matrix being implemented in a recursive manner by a unitary operator of a first type and a unitary operator of a second type; the unitary operator of the first type being used for performing phase shift on quantum states of n qubits, and the unitary operator of the second type being used for restoring quantum states of last rₜ qubits in the n qubits to quantum states when the diagonal unitary matrix is inputted; and the n qubits being qubits corresponding to the diagonal unitary matrix, 1≤rₜ<n≤N, and rₜ and n being integers.

According to an aspect of the embodiments of this application, a quantum state preparation method is provided, including:

obtaining a quantum state preparation circuit, the quantum state preparation circuit being obtained by respectively converting N qubit uniform control gates into a diagonal unitary matrix and a single bit gate in a quantum state intermediate preparation circuit that prepares a target vector on N qubits, the diagonal unitary matrix being implemented in a recursive manner by a unitary operator of a first type and a unitary operator of a second type, the unitary operator of the first type being used for performing phase shift on quantum states of n qubits, and the unitary operator of the second type being used for restoring quantum states of last rₜ qubits in the n qubits to quantum states when the diagonal unitary matrix is inputted; and the n qubits being qubits corresponding to the diagonal unitary matrix, 1≤rₜ<n≤N, and rₜ and n being integers; and

executing the quantum state preparation circuit on a quantum computing device including the N qubits.

According to an aspect of the embodiments of this application, a quantum state preparation circuit generation apparatus is provided, including:

a vector obtaining module, configured to obtain a target vector;

an intermediate circuit generation module, configured to generate a quantum state intermediate preparation circuit for preparing the target vector on N qubits, the quantum state intermediate preparation circuit including N qubit uniform control gates, and N being a positive integer greater than or equal to 2; and

a preparation circuit generation module, configured to respectively convert the N qubit uniform control gates into a diagonal unitary matrix and a single bit gate, to obtain a quantum state preparation circuit for preparing the target vector on the N qubits,

the diagonal unitary matrix being implemented in a recursive manner by a unitary operator of a first type and a unitary operator of a second type; the unitary operator of the first type being used for performing phase shift on quantum states of n qubits, and the unitary operator of the second type being used for restoring quantum states of last rₜ qubits in the n qubits to quantum states when the diagonal unitary matrix is inputted; and the n qubits being qubits corresponding to the diagonal unitary matrix, 1≤rₜ<n≤N, and rₜ and n being integers.

According to an aspect of the embodiments of this application, a quantum state preparation apparatus is provided, including:

a circuit obtaining module, configured to obtain a quantum state preparation circuit, the quantum state preparation circuit being obtained by respectively converting N qubit uniform control gates into a diagonal unitary matrix and a single bit gate in a quantum state intermediate preparation circuit that prepares a target vector on N qubits, the diagonal unitary matrix being implemented in a recursive manner by a unitary operator of a first type and a unitary operator of a second type, the unitary operator of the first type being used for performing phase shift on quantum states of n qubits, and the unitary operator of the second type being used for restoring quantum states of last rₜ qubits in the n qubits to quantum states when the diagonal unitary matrix is inputted; and the n qubits being qubits corresponding to the diagonal unitary matrix, 1≤rₜ<n≤N, and rₜ and n being integers; and

a circuit execution module, configured to execute the quantum state preparation circuit on a quantum computing device including the N qubits.

According to an aspect of the embodiments of this application, a quantum operation chip is provided, the quantum operation chip being configured to implement the quantum state preparation circuit generation method or the quantum state preparation method as described above.

According to an aspect of the embodiments of this application, a computer device is provided, including the quantum operation chip as described above.

According to an aspect of the embodiments of this application, a computer device is provided, including a processor and a memory, the memory storing at least one computer instruction, the at least one computer instruction being executed by the processor to implement the quantum state preparation circuit generation method or implement the quantum state preparation method as described above.

According to an aspect of the embodiments of this application, a quantum computer is provided, being configured to implement the quantum state preparation method as described above.

According to an aspect of the embodiments of this application, a non-transitory computer-readable storage medium is provided, storing at least one computer instruction, the at least one computer instruction being executed by a processor to implement the quantum state preparation circuit generation method or the quantum state preparation method as described above.

According to an aspect of the embodiments of this application, a computer program product is provided, including computer instructions, the computer instructions being executed by a processor to implement the quantum state preparation circuit generation method or the quantum state preparation method as described above.

The technical solutions provided in the embodiments of this application include at least the following beneficial effects:

based on a quantum state intermediate preparation circuit including N qubit uniform control gates, each of the qubit uniform control gates is respectively converted into a diagonal unitary matrix and a single bit gate. Through the unitary operator of the first type and the unitary operator of the second type, the diagonal unitary matrix is implemented in a recursive manner, and a quantum state preparation circuit with a circuit depth close to a lower bound of a theoretical depth can be constructed, thereby reducing a depth of the quantum state preparation circuit.

### BRIEF DESCRIPTION OF THE DRAWINGS

To describe the technical solutions in the embodiments of this application more clearly, the following briefly introduces the accompanying drawings for describing the embodiments. Apparently, the accompanying drawings in the following description show only some embodiments of this application, and a person of ordinary skill in the art may still derive other drawings from the accompanying drawings without creative efforts.

FIG. 1 is a schematic diagram of an application scenario of a solution according to an example embodiment of this application.

FIG. 2 is a flowchart of a quantum state preparation circuit generation method according to an example embodiment of this application.

FIG. 3 is a frame diagram of a quantum state intermediate preparation circuit involved in the example embodiment shown in FIG. 2.

FIG. 4 is a flowchart of a quantum state preparation circuit generation method according to an example embodiment of this application.

FIG. 5 is a design frame diagram of a diagonal unitary matrix circuit involved in the example embodiment shown in FIG. 4.

FIG. 6 is a schematic structural diagram of an operator gk involved in the example embodiment shown in FIG. 4.

FIG. 7 is a flowchart of a quantum state preparation method according to an example embodiment of this application.

FIG. 8 is a block diagram of a quantum state preparation circuit generation apparatus according to an example embodiment of this application.

FIG. 9 is a block diagram of a quantum state preparation apparatus according to an example embodiment of this application.

FIG. 10 is a structural block diagram of a computer device according to an example embodiment of this application.

### DESCRIPTION OF EMBODIMENTS

To make the objectives, technical solutions, and advantages of this application clearer, the following further describes implementations of this application in detail with reference to the accompanying drawings.

Before embodiments of this application are described, some terms involved in this application are explained first.

1) Quantum computation (QC): QC is a computing manner of using properties such as superposition and entanglement of quantum states to rapidly complete a computation task via quantum parallelism.

2) Quantum bit (Qubit): Qubits are a form or smallest carrier of carrying quantum information.

3) Quantum operation: A quantum operation refers to perform manipulation on the qubits to process the quantum information carried by the qubits. Common quantum operations include Pauli X, Y, Z transformation (or written as σₓ, σ_{y}, σ_{z}), Hadamard transformation (H), controlled Pauli X transformation, that is, a controlled-NOT gate CNOT, or the like. Only a single bit operation and a two-bit operation may be sufficient to complete any quantum computation, and are abbreviated as operations at some positions below.

4) Quantum circuit: A quantum circuit is a description model of the quantum computation, including the qubits and the quantum operations on the qubits. The quantum circuit includes a sequence of quantum gates, and computation is performed by the quantum gates.

5) Quantum computing device: A quantum computing device is a physical device that performs the quantum computation.

6) Quantum state preparation with no auxiliary bit: Definition of a question of the quantum state preparation with no auxiliary bit is as follows: Given any complex vector v=(v₀, v₁, v₂N₋₁)∈ [symbol] ²^{^{N}} that satisfies ∥v∥₂=1, and given an initial state |0 [symbol] ^{⊗N}, a quantum state of N bits is prepared with no auxiliary bit:

$$\vert {ψ}_{v} 〉 = {\sum }_{k = 0}^{{2}^{N} - 1} {v}_{k} \vert k 〉$$

{|k [symbol] k=0, 1, . . . , 2^{N}−1} is a set of computing bases for a quantum system. In the design of a quantum state preparation circuit, any single bit quantum gate and CNOT gate are allowed to be used. [symbol] ²^{^{N}} represents a set of complex vectors with a length of 2^{N}. In the quantum computation, a unit vector with a length of 2^{N} may be prepared in a quantum state of N qubits.

Current research indicates that a lower bound of a depth of the quantum state preparation circuit is Ω(2^{N}/N). Ω(·) is asymptotic lower bound notation, the meaning of

$$f ( N ) = Ω ( \frac{{2}^{N}}{N} )$$

is that there is a constant sum c>0 and N₀>0, and for any N≥N₀, f(N) satisfies

$$f ( N ) \geq c \cdot \frac{{2}^{N}}{N} .$$

7) Basic symbols: For ease of understanding, this application defines the following basic symbols:

[n] represents a set {1, 2, . . . , n}. [symbol] ₂ represents a binary domain. Any x=(x₁, . . . , xₙ)^{T}, y=(y₁, . . . , yₙ)^{T}∈{0,1}ⁿ, x⊕y=(x₁⊕y₁, . . . , xₙ⊕yₙ)^{T}, and an inner product [symbol] x, y [symbol] =⊕ᵢ₌₁ⁿxᵢyᵢ, where both addition and multiplication are defined on the binary field. 0ⁿ and 1ⁿ respectively represent vectors with a length of n and elements such as n and 1. {0,1}ⁿ is a set of vectors with a length of n and including 0 or 1. In some cases, {0,1}ⁿ also represents a set of bit strings with the length of n. eᵢ represents a vector whose i^{th} element is 1 and other elements are 0.

Some basic quantum gates involved in this application are shown in Table 1 below, where [symbol] is a set of real numbers.

TABLE 1

| Name | Definitions | Parameter |
|---|---|---|
| Rotation gate R_{y}(θ) | $[ \begin{matrix}cos ( θ / 2 ) & - sin ( θ / 2 ) \\ sin ( θ / 2 ) & cos ( θ / 2 )\end{matrix} ]$ | θ ∈ [symbol] |
| Rotation gate R_{z}(θ) | $[ \begin{matrix}{e}^{- i θ / 2} & \\ & {e}^{i θ / 2}\end{matrix} ]$ | θ ∈ [symbol] |
| Rotation gate R(θ) | $[ \begin{matrix}1 & \\ & {e}^{i θ}\end{matrix} ]$ | θ ∈ [symbol] |
| Hadamard gate H | $\frac{1}{\sqrt{2}} [ \begin{matrix}1 & 1 \\ 1 & - 1\end{matrix} ]$ | Null |
| Phase gate S | $[ \begin{matrix}1 & \\ & i\end{matrix} ]$ | Null |
| CNOT gate | $[ \begin{matrix}1 & & & \\ & 1 & & \\ & & & 1 \\ & & 1 & \end{matrix} ]$ | Null |
| n qubit uniform control gate Vₙ | $[ \begin{matrix}{U}_{1} & & & \\ & {U}_{2} & & \\ & & ⋱ & \\ & & & {U}_{{2}^{n - 1}}\end{matrix} ]$ | ∀k ∈ [2ⁿ⁻¹], and Uₖ ∈ [symbol] ^{2×2} is a unitary matrix |
| n qubit diagonal unitary matrix Λₙ | $[ \begin{matrix}1 & & & \\ & {e}^{i {θ}_{1}} & & \\ & & ⋱ & \\ & & & {e}^{i {θ}_{{2}^{n} - 1}}\end{matrix} ]$ | θ₁, θ₂, . . . , θ₂_{ⁿ}₋₁ ∈ [symbol] |

8) Decomposition of a single bit quantum gate. For any single bit quantum gate U∈ [symbol] ^{2×2} there are real numbers α, β, γ, δ∈ [symbol] , and U may be decomposed into the following form:

U=e^{iα}R_{z}(β)SHR_{z}(γ)HS^{†}R_{z}(δ) (1.)

9) i-Gray code cycle. The Gray code circle is a sequence of all n-bit strings (that is, a bit string with n bits) in {0,1}ⁿ, which satisfies that one bit in two adjacent bit strings differs, and one bit in a first bit string and one bit in a last bit string are different.

The construction of the Gray code circle is not unique. For any i∈[n], c₁ⁱ, c₂ⁱ, . . . , c₂n₋₁ⁱ, c₂nⁱ is enabled to represent n bit string sequence, and for any i∈[n], c₁ⁱ=0ⁿ. For any j∈{2, 3, . . . , 2ⁿ}, hᵢⱼ represents subscripts of different bits of cⱼ₋₁ⁱ and cⱼⁱ. hᵢ₁ is enabled to represent subscripts of different bits of c₁ⁱ and c₂_{ⁿ}ⁱ, and then:

$${h}_{ij} = \{ \begin{matrix}{r}_{c} , & if i = j = 1 \\ i - 1 , & if i ∈ \{ 2 , 3 , … , n \} and j = 1 \\ max \{ k : {2}^{k} \vert 2 ( j - 1 ) \} , & if i = 1 and j ∈ \{ 2 , 3 , … , {2}^{n} \} \\ {h}_{1 j} + i - 1 , & if {h}_{1 j} + i - 1 \leq n and j ∈ \{ 2 , 3 , … , {2}^{n} \} \\ {h}_{1 j} + i - 1 - {r}_{c} , & if {h}_{1 j} + i - 1 > n and j ∈ \{ 2 , 3 , … , {2}^{n} \}\end{matrix} \qquad ( 2. )$$

The binary code c₁ⁱ, c₂ⁱ, . . . , c₂_{ⁿ}₋₁ⁱ, c₂_{ⁿ}ⁱ is the Gray code circle. In this embodiment of this application, the bit string sequence c₁ⁱ, c₂ⁱ, . . . , c₂_{ⁿ}₋₁ⁱ, c₂_{ⁿ}ⁱ may be referred to as (i, n)-Gray code circle, and may also be referred to as i-Gray code circle for short.

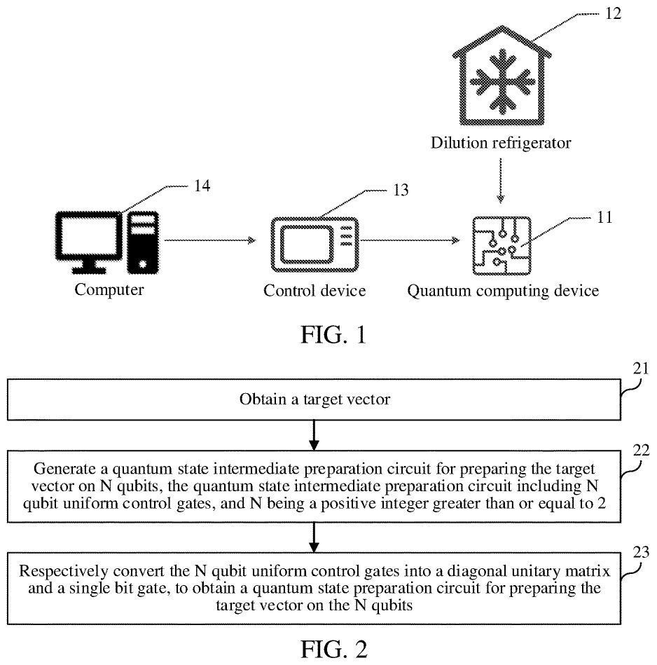

FIG. 1 is a schematic diagram of an application scenario of a solution according to an embodiment of this application. As shown in FIG. 1, the application scenario may be a superconducting quantum computing platform, and the application scenario includes: a quantum computing device 11, a dilution refrigerator 12, a control device 13, and a computer 14.

The quantum computing device 11 is a circuit that is applied on a physical qubit, and the quantum computing device 11 may be implemented as a quantum chip, such as a superconducting quantum chip maintained at close to absolute zero temperature. The dilution refrigerator 12 is configured to provide a close-to-absolute zero environment for the superconducting quantum chip.

The control device 13 is configured to control the quantum computing device 11, and the computer 14 is configured to control the control device 13. For example, a written quantum program is compiled into instructions by software in the computer 14 and transmitted to the control device 13 (such as an electronic/microwave control system). The control device 13 converts the instructions into an electronic/electromagnetic (e.g., microwave) control signal and inputs the instructions to the dilution refrigerator 12 to control a superconducting qubit at a temperature of lower than 10 mK. A process of reading is reversed, and a read waveform is delivered to the quantum computing device 11.

Before the method embodiments of this application are described, a running environment of the methods is described first. The quantum state preparation circuit generation method or the quantum state preparation method provided in this embodiment of this application may be implemented by a classical computer (such as a personal computer (PC), or may also be executed in a hybrid device environment of a classical computer and a quantum computer, or may also be implemented by a quantum computer.

FIG. 2 is a flowchart of a quantum state preparation circuit generation method according to an embodiment of this application. An execution entity of each step of the method may be a computer device. The method may include the following steps:

Step 21. Obtain a target vector.

Step 22. Generate a quantum state intermediate preparation circuit for preparing the target vector on N qubits, the quantum state intermediate preparation circuit including N qubit uniform control gates. and N being a positive integer greater than or equal to 2.

In this embodiment of this application, for a given target vector, a quantum state intermediate preparation circuit including N qubit uniform control gates, and located on N qubits may be generated.

When the quantum state intermediate preparation circuit is executed, the target vector may be prepared on the N qubits. Current research indicates that a circuit depth of the quantum state intermediate preparation circuit is: O(2^{N}).

Step 23. Respectively convert the N qubit uniform control gates into a diagonal unitary matrix and a single bit gate, to obtain a quantum state preparation circuit for preparing the target vector on the N qubits.

The diagonal unitary matrix is implemented in a recursive manner by a unitary operator of a first type (U operator) and a unitary operator of a second type; the unitary operator of the first type is used for performing phase shift on quantum states of n qubits, and the unitary operator of the second type is used for restoring quantum states of last rₜ qubits in the n qubits to quantum states in when the diagonal unitary matrix is inputted; and the n qubits include qubits corresponding to the diagonal unitary matrix, 1≤rₜ<n≤N, and rₜ and n are integers.

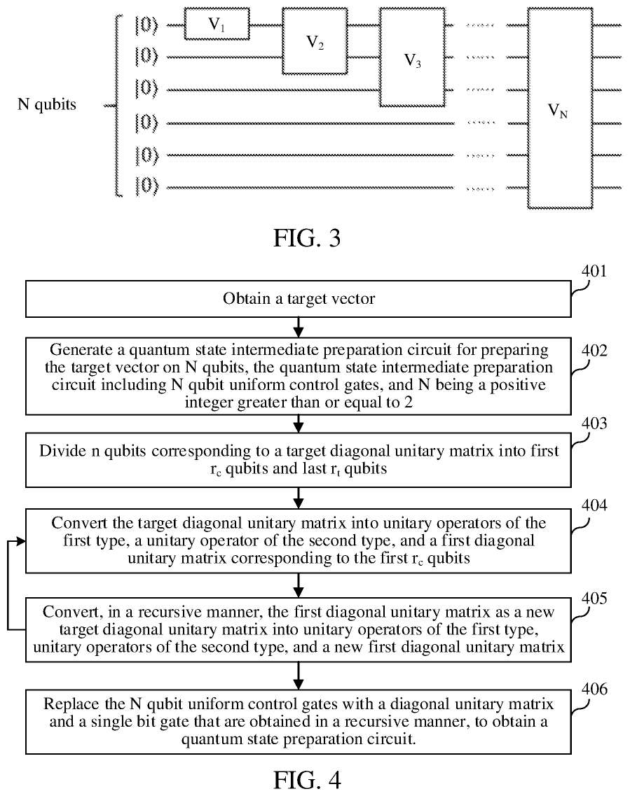

In this embodiment of this application, a frame diagram of the quantum state intermediate preparation circuit may be as shown in FIG. 3.

In the framework of the quantum state preparation circuit involving N qubits shown in FIG. 3, an initial state of the circuit is |0 [symbol] ^{⊗N}. For any n∈[N], Vₙ represents a uniform control gate for the n^{th} qubit.

According to equation (1), a diagonal submatrix of a uniform control gate Vₙ for any n qubit may be decomposed as follows:

Uₖ=e^{iα}^{ₖ}R_{z}(βₖ)SHR_{z}(γₖ)HS^{\}R_{z}(δₖ),αₖ,βₖ,γₖ,δₖ∈ [symbol] ,k∈[2ⁿ⁻¹]

Therefore, the uniform control gate Vₙ may be decomposed into the following form:

$${V}_{n} = [ \text{} \begin{matrix}{e}^{i {α}_{1}} & & & & \\ & {e}^{i {α}_{1}} & & & \\ & & ⋱ & & \\ & & & {e}^{i {α}_{2} n - 1} & \\ & & & & {e}^{i {α}_{2} n - 1}\end{matrix} ] \cdot [ \text{} \begin{matrix}{R}_{z} ( {β}_{1} ) & & \\ & ⋱ & \\ & & {R}_{z} ( {β}_{{2}^{n - 1}} )\end{matrix} ] \cdot {II}_{n - 1} ⊗ ( SH ) .$$

$$[ \begin{matrix}{R}_{z} ( {γ}_{1} ) & & \\ & ⋱ & \\ & & {R}_{z} ( {γ}_{{2}^{n - 1}} )\end{matrix} ] \cdot {II}_{n - 1} ⊗ ( {HS}^{†} ) \cdot [ \begin{matrix}{R}_{z} ( {δ}_{1} ) & & \\ & ⋱ & \\ & & {R}_{z} ( {δ}_{{2}^{n - 1}} )\end{matrix} ] ,$$

where [symbol] ₙ₋₁ represents a unit operator of n−1 qubits ( [symbol] ₙ₋₁ represents an identity matrix with a scale of 2ⁿ⁻¹×2ⁿ⁻¹. In the quantum computation, an operator with a scale of 2ⁿ⁻¹×2ⁿ⁻¹ may be implemented on n−1 qubits, and therefore the operator is referred to as a unit operator of n−1 qubits). Therefore, an S gate and an H gate are combined into a single bit gate, a global phase is ignored, and any n qubit uniform control gate may include three n qubit diagonal unitary matrices Λₙ and two single bit gates. When D(n) is enabled to represent no auxiliary bit, a depth of the quantum circuit of Λₙ is implemented. A global phase of V₁, . . . , V_{N} may be implemented by a single bit phase gate. It may be learnt from the circuit framework in FIG. 1 that a circuit depth of any N bit quantum state preparation circuit is:

$${\sum }_{n = 1}^{N} ( 3 D ( n ) + 2 ) + 1 = 3 {\sum }_{n = 1}^{N} D ( n ) + 2 N + 1 \qquad ( 3. )$$

It may be seen that when there is no auxiliary bit, provided that a depth of the diagonal unitary matrix Λₙ is designed as O(2ⁿ/n) quantum circuit, a quantum state preparation circuit with a depth of 3 Σₙ₌₁^{N} O(2ⁿ/n)+2N+1=O(2^{N}/N) may be directly obtained.

In the solution shown in this application, the Λₙ is converted into a diagonal unitary matrix and a single bit gate, and the diagonal unitary matrix is implemented in a recursive manner through the unitary operator of the first type and the unitary operator of the second type, thereby reducing the circuit depth of the quantum state preparation circuit.

In summary, in the solution shown in this embodiment of this application, based on a quantum state intermediate preparation circuit including N qubit uniform control gates, each of the qubit uniform control gates is respectively converted into a diagonal unitary matrix and a single bit gate. Through the unitary operator of the first type and the unitary operator of the second type, the diagonal unitary matrix is implemented in a recursive manner, and a quantum state preparation circuit with a circuit depth close to a lower bound of a theoretical depth limit can be constructed, thereby reducing a depth of the quantum state preparation circuit.

FIG. 4 is a flowchart of a quantum state preparation circuit generation method according to an embodiment of this application. An execution entity of each step of the method may be a computer device. The method may include the following steps:

Step 401. Obtain a target vector.

The solution shown in this embodiment of this application is a basic step in the quantum algorithm, where optimizing a depth of the quantum state preparation circuit helps to optimize a circuit depth of the quantum algorithm. The quantum state preparation is widely used in quantum machine learning algorithms. For example, in machine learning algorithms such as a quantum support vector machine, quantum least squares fitting, a Boltzmann machine, and quantum linear equation solving, the quantum device needs to read classical data. That is, a data vector x=(x₁, . . . , x_{N})^{T}∈ [symbol] ^{N} (that is, the target vector) is encoded into a quantum state

$$\vert x 〉 = \frac{1}{\sqrt{{‖ x ‖}_{2}}} {\sum }_{k = 1}^{N} {x}_{i} \vert i 〉 ,$$

and the step is the quantum state preparation. In these quantum algorithms, the main cost is the cost spent on the step of the quantum state preparation. Therefore, when the quantum state preparation circuit is optimized, an optimized circuit of the quantum machine learning algorithm may be directly obtained.

Step 402. Generate a quantum state intermediate preparation circuit for preparing the target vector on N qubits, the quantum state intermediate preparation circuit including N qubit uniform control gates. and N being a positive integer greater than or equal to 2.

A framework of the quantum state intermediate preparation circuit may be as shown in FIG. 3, which is not repeated herein.

After the quantum state intermediate preparation circuit is obtained, the N qubit uniform control gates are respectively converted into a diagonal unitary matrix and a single bit gate, to obtain a quantum state preparation circuit for preparing the target vector on the N qubits.

It may be learnt from the Table 1 that the role of the diagonal unitary matrix Λₙ is to implement the following transformations on each vector |x [symbol] on the computing base:

|x [symbol] →e^{iθ(x)}|x [symbol] , ∀x∈{0,1}ⁿ

It is assumed that the following two tasks may be implemented:

1) For any s∈{0,1}ⁿ−{0ⁿ}, {0,1}ⁿ represents a set of all bit strings with a length of n, and {0,1}ⁿ−{0ⁿ} represents a set of all bit strings with a length of n except for 0ⁿ. When x satisfies [symbol] s,x [symbol] =1, phase shift of αₛ is performed on a basis vector |x [symbol] , that is:

|x [symbol] →Πₛ [symbol] |x

[symbol]

2) It is found that {αₛ: s∈{0,1}ⁿ−{0ⁿ}} satisfies:

Σₛ [symbol] s,x [symbol] αₛ=θ(x), ∀x∈{0,1}ⁿ−{0ⁿ} (4.)

For all s∈{0,1}ⁿ−{0ⁿ}, quantum circuits corresponding to a transformation |x [symbol] → [symbol] |x [symbol] are lined up to implement Λₙ:

|x [symbol] →Πₛ [symbol] |x [symbol] = [symbol] |x [symbol] =e^{iθ(x)}|x

[symbol]

Based on the foregoing principles, for a manner of respectively converting each of the N qubit uniform control gates into the diagonal unitary matrix and the single bit gate, reference may be made to the subsequent steps.

Step 403. Divide n qubits corresponding to a target diagonal unitary matrix into first r_{c} qubits and last rₜ qubits.

A value of r_{c} is ┌n/2┐, and a value of rₜ is └n/2┘; and the target diagonal unitary matrix is a qubit diagonal unitary matrix obtained by decomposing any one of the qubit uniform control gates. ┌n/2┐represents rounding down to n/2, and └n/2┘ represents rounding up to n/2.

Step 404. Convert the target diagonal unitary matrix into [symbol] unitary operators of the first type, a unitary operator of the second type, and a first diagonal unitary matrix corresponding to the first r_{c} qubits.

$$ℓ \leq 4 ⌈ \frac{{2}^{{r}_{t}}}{{r}_{t} + 1} ⌉ - 1 ,$$

and [symbol] a positive integer.

Step 405. Convert, in a recursive manner, the first diagonal unitary matrix as a new target diagonal unitary matrix into unitary operators of the first type, unitary operators of the second type, and a new first diagonal unitary matrix.

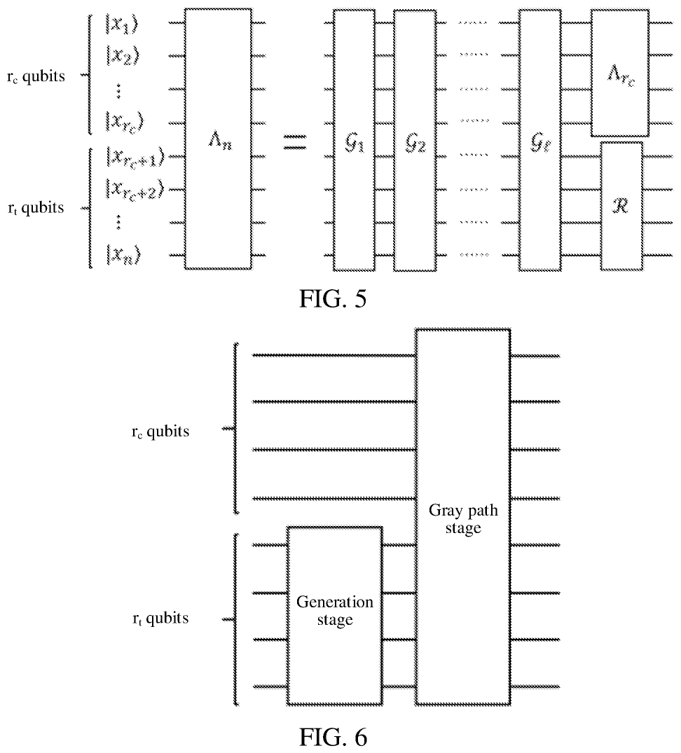

FIG. 5 shows a design frame diagram of a diagonal unitary matrix circuit involved in an embodiment of this application. As shown in FIG. 5, in the quantum circuit framework of the diagonal unitary matrix Λₙ with no auxiliary bit, rₜ=└n/2┘, r_{c}=n−rₜ=┌n/2┐, and

$$ℓ \leq 4 ⌈ \frac{{2}^{{r}_{t}}}{{r}_{t} + 1} ⌉ - 1 .$$

For any k∈[ [symbol] ] a circuit depth of an operator [symbol] is O(2^{r}^{_{c}}), and a circuit depth of an operator [symbol] is

$$O ( \frac{{r}_{t}}{log {r}_{t}} ) .$$

As shown in FIG. 5, an operating register of the n qubits is divided into two parts: a control register including the first r_{c} qubits, and the target register including the last rₜ qubits. The quantum circuit of the diagonal unitary matrix Λₙ includes the following operators:

1) Unitary operators [symbol] ₁, [symbol] ₂, . . . [symbol] of the n-qubit, that is, the unitary operator of the first type; and a structure of the operator is introduced in the subsequent content of this embodiment of this application.

2) A unitary operator [symbol] of the rₜ-qubit, that is, the unitary operator of the second type, which is used for restoring the target register to an initial state. That is, a quantum state of the target register changes during the execution of the circuit, but as the circuit is executed, the circuit changes to a state during inputting.

3) A diagonal unitary matrix operator Λᵣ_{_{c}} for r_{c}-qubits. The operator is implemented in a recursive manner in a similar manner to Λₙ until there are no unimplemented diagonal unitary matrices.

The parameters are defined as follows:

$${r}_{t} = ⌊ n / 2 ⌋ \approx n / 2$$

$${r}_{c} = ⌈ n / 2 ⌉ \approx n / 2$$

$$ℓ = 4 ⌈ {2}^{{r}_{t}} / ( {r}_{t} + 1 ) ⌉ - 1 \approx {2}^{\frac{n}{2} + 3} / n$$

Functions of operators in the circuit framework in FIG. 5 are induced below. In this embodiment of this application, functions of operators under any computing base are introduced. The any computing base is defined as follows:

$$\vert x 〉 = \vert {x}_{1} {x}_{2} … {x}_{{r}_{c}} {x}_{{r}_{c} + 1} … x 〉 = \underbrace{\vert {x}_{control} 〉}_{{r}_{c} qubits} \underbrace{\vert {x}_{target} 〉}_{{r}_{t} qubits} , ∀ x ∈ {\{ 0 , 1 \}}^{n} ,$$

where x_{control} represents x₁x₂ . . . xᵣ_{_{c}}, and x_{target} represents xᵣ_{_{c}}₊₁ . . . xₙ.

In this embodiment of this application, the basic idea of the quantum circuit structure is first introduced. For the ease of description, “generating a quantum state | [symbol] s,x [symbol] [symbol] on a qubit” is referred to as “generating a bit string s on a qubit”. The n-bit string s∈{0,1}ⁿ−{0ⁿ} is divided into two parts, s=ct, where c is referred to as a prefix of an r_{c} bit, and t is referred to as a suffix of an rₜ bit.

In this embodiment of this application, n bit strings may be generated except for 0ⁿ. 2^{r}^{ₜ}−1 suffixes are divided into [symbol] sets T⁽¹⁾, T⁽²⁾, . . . , [symbol] , a value of each set is rₜ, strings in the sets are linearly independent in finite fields [symbol] ₂, and elemental coincidence between the sets is allowed. 2^{r}^{ₜ}−1 suffixes refer to suffixes except for 0^{r}^{ₜ} in all the bit strings in {0,1}ⁿ−{0ⁿ}. Φ unitary operators [symbol] ₁, [symbol] , . . . , [symbol] correspond to [symbol] generation stages. In the k∈[ [symbol] ]^{th} generation stage, all bit strings with the string in T^{(k)} as a suffix are respectively generated on each qubit of a target register.

The meaning of generating a plurality of bit strings in a stage is that quantum states | [symbol] , x [symbol] [symbol] corresponding to these bit strings s appear in a stage. For example, if three bit strings s₁, s₂, and s₃ need to be generated on a qubit, then | [symbol] , x [symbol] [symbol] is first generated, then | [symbol] , x [symbol] [symbol] is converted into | [symbol] ₂, x [symbol] [symbol] , and finally | [symbol] ₂, x [symbol] [symbol] is converted into | [symbol] ₃, x [symbol] [symbol] . The process may be referred to as a process of generating three bit strings s₁, s₂, and s₃.

The linear independence of the set T^{(k)} may ensure that transitions between stages may be implemented in a circuit with a low depth. After the first [symbol] stages are over, a bit string with a suffix of 0^{r}^{ₜ} is generated in a recursive manner, that is s=c0^{r}^{ₜ}.

To describe the function of each operator more clearly, some basic symbols are introduced first.

$$ℓ \leq 4 ⌈ \frac{{2}^{{r}_{t}}}{{r}_{t} + 1} ⌉ - 1$$

sets T⁽¹⁾, T⁽²⁾, . . . , [symbol] that satisfy the following two properties are defined:

1) For each k∈[ [symbol] ], the set T^{(k)}={t₁^{(k)}, t₂^{(k)}, . . . tᵣ_{ₜ}^{(k)}}⊆{0,1}^{r}^{ₜ} is linearly independent over a finite field [symbol] ₂; and

2) The set T⁽¹⁾, T⁽²⁾, . . . , [symbol] may cover the set {0,1}^{r}^{ₜ}−{0^{r}^{ₜ}}, that is, [symbol] T^{(k)}={0,1}^{r}^{ₜ}−{0^{r}^{ₜ}}.

A structure of the set T⁽¹⁾, T⁽²⁾, . . . , [symbol] is introduced in the subsequent content of this application. For each k∈[ [symbol] ]∪{0}, a quantum state of the rₜ bit is defined:

$$\vert {y}^{( k )} 〉 = \vert {y}_{1}^{( k )} {y}_{2}^{( k )} … {y}_{{r}_{t}}^{( k )} 〉 , {y}_{j}^{( k )} = \{ \begin{matrix}{x}_{{r}_{c} + j} , & if k = 0 \\ 〈 {0}^{{r}_{c}} {t}_{j}^{( k )} , x 〉 , & if k ∈ [ ℓ ]\end{matrix} \qquad ( 5. )$$

That is, y⁽⁰⁾ and x_{target} are the same, and yⱼ^{(k)} is a linear function related to 0^{r}^{_{ct}}ⱼ^{(k)}. Sets F₁, F₂, . . . , F [symbol] that do not intersect with each other are defined below:

$$\{ \begin{matrix}{F}_{1} = \{ ct : t ∈ {T}^{( 1 )} , c ∈ {\{ 0 , 1 \}}^{{r}_{c}} \} \\ {F}_{k} = \{ ct : t ∈ {T}^{( k )} , c ∈ {\{ 0 , 1 \}}^{{r}_{c}} \} - {⋃}_{d ∈ [ k - 1 ]} {F}_{d} , k ∈ \{ 2 , 3 , … , ℓ \}\end{matrix} \qquad ( 6. )$$

For any i≠j∈[ [symbol] ], the set F₁, F₂, . . . , [symbol] satisfy Fᵢ∩Fⱼ=Ø, and

$${⋃}_{k ∈ [ ℓ ]} {F}_{k} = {\{ 0 , 1 \}}^{{r}_{c}} \times {⋃}_{k ∈ [ ℓ ]} {T}^{( k )} = {\{ 0 , 1 \}}^{{r}_{c}} \times ( {\{ 0 , 1 \}}^{{r}_{t}} - \{ {0}^{{r}_{t}} \} ) = {\{ 0 , 1 \}}^{n} - \{ c {0}^{{r}_{t}} : c ∈ {\{ 0 , 1 \}}^{{r}_{c}} \} \qquad ( 7. )$$

The effects of operators [symbol] ₖ, [symbol] , and Λᵣ_{_{c}} are described below, and a structure of the operators is introduced.

For any k∈ [symbol] ],

[symbol]

ₖ|x_{control} [symbol] |y^{(k-1)} [symbol] = [symbol] y^{(k)} [symbol] (8.)

αₛ is determined by equation (4). The operator [symbol] ₖ has two functions: first, a phase is introduced based on a k−1 stage, that is [symbol] , and second, a step k−1 is transited to a step k.

The operator [symbol] is applied on the target register, which restores a quantum state corresponding to a suffix to an input state [symbol] in equation (8) is defined by the suffix, and therefore, [symbol] is referred to as the quantum state corresponding to the suffix), that is,

[symbol]

| [symbol] =|y⁽⁰⁾ [symbol] (9.)

The operator Λᵣ_{_{c}} is a diagonal unitary matrix of the r_{c} qubit, satisfying

Λᵣ_{_{c}}|x_{control} [symbol] = [symbol] |x_{control} [symbol] (10.)

The operator Λᵣ_{_{c}} is implemented in a recursive manner.

Equation (10) is the definition of the diagonal unitary matrix Λᵣ_{_{c}} of the r_{c} qubit. In a structure of a subsequent circuit, Λᵣ_{_{c}} is a module in a circuit that implements Λₙ, and a structure of a quantum circuit corresponding to Λᵣ_{_{c}} is unknown. Implementing Λᵣ_{_{c}} in a recursive manner refers to the following process:

In the subsequent structure, a circuit of the n qubit diagonal unitary matrix Λₙ may be divided into two parts, with one part being a designed circuit, and the other part being an undesigned diagonal unitary matrix Λᵣ_{_{c}} of the r_{c}(<n) qubit. The diagonal unitary matrix Λᵣ_{_{c}} may be implemented by the circuit implementation of Λₙ. That is, a circuit of Λᵣ_{_{c}} may be divided into two parts, with one part being the designed circuit, and the other part being the undesigned diagonal unitary matrix Λᵣ_{_{c}}_{¹} of the r_{c}¹(<r_{c}) qubit. The diagonal unitary matrix Λᵣ_{_{c}}_{¹} may be decomposed in a similar method until there is no undesigned diagonal unitary matrix in the circuit.

For any input quantum state |x [symbol] , the quantum circuit may implement the following transformation:

$$\vert x 〉 = \vert {x}_{control} 〉 \vert {y}^{( 0 )} 〉$$

$${\to }^{{𝒢}_{1}} {e}^{i {\sum }_{∈ {F}_{1}} 〈 s , x 〉 {α}_{s}} \vert {x}_{control} 〉 \vert {y}^{( 1 )} 〉$$

$${\to }^{{𝒢}_{2}} {e}^{i {\sum }_{∈ {F}_{1} ⋃ {F}_{2}} 〈 s , x 〉 {α}_{s}} \vert {x}_{control} 〉 \vert {y}^{( 2 )} 〉$$

$$⋮$$

$${\to }^{{𝒢}_{ℓ}} {e}^{i {\sum }_{s ∈ {⋃}_{k ∈ [ ℓ ]} {F}_{k} 〈 s , x 〉 {α}_{s}}} \vert {x}_{control} 〉 \vert {y}^{( ℓ )} 〉$$

$${\to }^{{𝕀}_{{r}_{c}} ⊗ ℛ} {e}^{i {\sum }_{s ∈ {⋃}_{k ∈ [ ℓ ]} {F}_{k} 〈 s , x 〉 {α}_{s}}} \vert {x}_{control} 〉 \vert {y}^{( 0 )} 〉$$

$${\to }^{{Λ}_{{r}_{c}} ⊗ {𝕀}_{{r}_{t}}} {e}^{i {\sum }_{s ∈ ( {⋃}_{k ∈ [ ℓ ]} {F}_{k} ) ⋃ ( {\{ c {0}^{{r}_{t}} \}}_{c ∈ \{ 0 , 1 \}} {r}_{c - \{ {0}^{r} c \}} )} 〈 s , x 〉 {α}_{s}} \vert {x}_{control} 〉 \vert {y}^{( 0 )} 〉 = {e}^{i {\sum }_{s ∈ {\{ 0 , 1 \}}^{n} - \{ {0}^{n} \}} 〈 s , x 〉 {α}_{s}} \vert {x}_{control} 〉 \vert {y}^{( 0 )} 〉 = {e}^{i θ ( x )} \vert {x}_{control} 〉 \vert {y}^{( 0 )} 〉$$

It is learned that for a real number α>0, a circuit depth of the operator [symbol] ₖ is at most α·2^{r}^{_{c}}. In addition, for a real number β>0, a circuit depth of the operator [symbol] is at most β·rₜ/log rₜ.

Therefore, D(n) satisfies the following recursive formula:

$$D ( n ) \leq max \{ D ( {r}_{c} ) , β \cdot \frac{{r}_{t}}{log {r}_{t}} \} + α \cdot {2}^{{r}_{c}} \cdot ℓ \leq D ( ⌈ n / 2 ⌉ ) + β \cdot \frac{⌈ n / 2 ⌉}{log ⌈ n / 2 ⌉} + α \cdot {2}^{⌈ n / 2 ⌉} \cdot ( 4 ⌈ \frac{{2}^{⌈ n / 2 ⌉}}{⌊ n / 2 ⌋ + 1} ⌉ - 1 ) = D ( ⌈ n / 2 ⌉ ) + O ( \frac{{2}^{n}}{n} )$$

It may be learnt from the recursive formula that D(n)=O(2ⁿ/n).

The unitary operator of the first type includes a generated unitary operator and a Gray path unitary operator. The generated unitary operator is used for converting a computing base into invertible linear transformation over a finite field on the last rₜ qubits; and the Gray path unitary operator is used for implementing the phase shift on the quantum states of the n qubits through a Gray code circle whose quantity of bits is r_{c}.

In the structure of the unitary operator of the first type, based on the phase shift being performed on the quantum states in the first r_{c} qubits, the quantum states of the last rₜ qubits may further be restored, so that the quantum state preparation circuit may accurately prepare the quantum states of specific qubits.

FIG. 6 is a schematic structural diagram of an operator [symbol] ₖ according to an embodiment of this application. As shown in FIG. 6, the operator [symbol] ₖ includes two stages: a generation stage and a Gray path stage.

The generated unitary operator is used for updating the quantum states of the last rₜ qubits through a bit string set T; and the bit string set T includes bit strings with a length of rₜ and including elements 0 and 1, and the bit strings included in the bit string set T are linearly independent.

The feature of being linearly independent in the bit strings included in the bit string set T may support the unitary operator of the first type to restore the quantum states of the last rₜ qubits.

The generated unitary operator is implemented by a controlled-NOT gate CNOT; and a depth of the generated unitary operator is O(rₜ/log rₜ).

This embodiment of this application provides a solution for implementing the generated unitary operator by using an operator with a depth of O(rₜ/log rₜ), so that the unitary operator of the first type may restore the quantum states of the last rₜ qubits, and may further control the depth of the unitary operator of the first type.

In this embodiment of this application, the unitary operator of the second type is implemented by a CNOT with a depth of O(rₜ/log rₜ).

This embodiment of this application provides a solution for implementing the unitary operator of the second type by using an operator with a depth of O(rₜ/log rₜ), so that the depth of the unitary operator of the second type may be controlled.

In the generation stage, the operator U_{Gen}^{(k)} implemented by this application satisfies:

$$\vert {y}^{( k - 1 )} 〉 {\to }^{{U}_{G e n}^{( k )}} \vert {y}^{( k )} 〉 , k ∈ [ ℓ ] , \qquad ( 11. )$$

where definitions of y^{(k-1)} and y^{(k)} defined in equation (5) and are respectively determined by a set T^{(k-1)} and a set T^{(k)}. For k∈[ [symbol] ]∪{0}, definition T^{(k)}={t₁^{(k)}, t₂^{(k)}, . . . tᵣ_{ₜ}^{(k)}} of T^{(k)} is reviewed. An order of elements in the set is fixed. For any k∈[ [symbol] ], a matrix \hat{T}^{(k)}=[t₁^{(k)}, t₂^{(k)}, . . . tᵣ_{ₜ}^{(k)}]^{T}∈{0,1}^{r}^{ₜ}^{×r}^{ₜ} is defined; and when k=0, \hat{T}=⁽⁰⁾∈{0,1}^{r}^{ₜ}^{×r}^{ₜ}. Therefore, a vector y^{(k)} may be written as:

y^{(k)}\hat{T}^{(k)}x_{target} (12.)

Because t₁^{(k)}, t₂^{(k)}, . . . tᵣ_{ₜ}^{(k)} are linearly independent over the finite field [symbol] ₂, \hat{T}^{(k)} is invertible over the finite field [symbol] ₂. The unitary operator is defined:

U_{Gen}^{(k)}|y [symbol] =|\hat{T}^{(k)}(\hat{T}^{(k-1)})⁻¹y

[symbol]

The matrix vector multiplication on the right-hand side of the equation is defined over the finite field [symbol] ₂. It may be obtained from equation (12):

U_{Gen}^{(k)}|y^{(k-1)} [symbol] =|\hat{T}^{(k)}(\hat{T}^{k-1)})⁻¹y^{(k-1)} [symbol] =|\hat{T}^{(k)}x_{target} [symbol] =|y^{(k)}

[symbol]

Equation (11) is satisfied. In addition, U_{Gen}^{(k)} converts the computing base into invertible linear transformation over the finite field [symbol] ₂. Therefore, assuming that U is a unitary matrix that performs permutation on the computing base, as a mapping on the computing base, U is invertible linear transformation over the finite field [symbol] ₂. Then, with no auxiliary bit, U may be implemented by a CNOT quantum circuit with a circuit depth of at most O(n/log n).

That is, with no auxiliary bit, the generation stage U_{Gen}^{(k)} may be implemented by a CNOT circuit with a depth of O(rₜ/log rₜ).

Similar to the discussion of the operator U_{Gen}^{(k)}, the operator [symbol] may be defined as:

[symbol]

|y [symbol] =| [symbol] )⁻¹y

[symbol]

Then,

[symbol]

| [symbol] =|( [symbol] )⁻¹ [symbol] =|x_{target} [symbol] =|y⁽⁰⁾

[symbol]

Therefore, the operator [symbol] is invertible linear transformation over the finite field [symbol] ₂. Therefore, with no auxiliary bit, the operator [symbol] may be implemented by a CNOT circuit with a depth of O(rₜ/log rₜ).

In addition, in this application, there is a set T⁽¹⁾, T⁽²⁾, . . . , [symbol] ⊆{0,1}^{r}^{ₜ}−{0^{r}^{ₜ}}. For a specific integer

$$ℓ \leq 4 ⌈ \frac{{2}^{{r}_{t}}}{{r}_{t} + 1} ⌉ - 1 ,$$

the following three properties are satisfied:

1) for any i∈ [symbol] , |T⁽ⁱ⁾|=rₜ;

2) for any i∈ [symbol] , Boolean vectors in T⁽ⁱ⁾={t₁⁽ⁱ⁾, t₂⁽ⁱ⁾, . . . tᵣ_{ₜ}⁽ⁱ⁾} are linearly independent over the finite field [symbol] ₂; and

3) [symbol] T⁽ⁱ⁾={0,1}^{r}^{ₜ}−{0^{r}^{ₜ}}.

[symbol]

For any n-bit vector x∈{0,1}^{r}^{ₜ}, a set Sₓ={x⊕e₁, x⊕e₂, . . . , x⊕eᵣ_{ₜ}} is defined. First, a set L⊆{0,1}^{r}^{ₜ} that satisfies

$$\vert L \vert \leq 2 ⌈ \frac{{2}^{{r}_{t}}}{{r}_{t} + 1} ⌉$$

is constructed, and {0,1}^{r}^{ₜ}=(U_{x∈L} Sₓ)∪L. k=└log(rₜ+1)┘. For t∈[rₜ], k bit binary of t∈[rₜ] is represented as tₖtₖ₋₁ . . . t₂t₁, where t₁, . . . , tₖ∈{0,1}, and t=Σᵢ₌₁^{k}tᵢ2ⁱ⁻¹ is satisfied. The overscore is used to represent a column vector corresponding to the integer, that is:

t̅=[t₁,t₂, . . . ,tₖ]^{T}∈{0,1}^{k}

A Boolean matrix H with a scale of k×rₜ is defined, including a vector 1̅, 2̅, . . . , r̅ₜ̅, that is:

H=[1̅,2̅, . . . ,r̅ₜ̅]∈{0,1}^{k×r}^{ₜ}

A k dimensional identity matrix Iₖ−[, 2̅⁰̅, 2̅¹̅ . . . , 2̅^̅{̅k̅-̅1̅}̅ ] is a submatrix of a matrix H, and therefore, rank(H)=k. The following sets are defined:

L⁽⁰⁾={x∈{0,1}^{r}^{ₜ}:Hx=0^{k}}, L⁽¹⁾={x∈{0,1}^{r}^{ₜ}:Hx=1^{k}} (13.)

A⁽⁰⁾={x∈{0,1}^{r}^{ₜ}:(Hx)ₖ=0}, A⁽¹⁾={x∈{0,1}^{r}^{ₜ}:(Hx)ₖ1} (14.)

For each x∈{0,1}^{r}^{ₜ}, the last bit of Hx is 0 or 1, and therefore A⁽⁰⁾∪A⁽¹⁾={0,1}^{r}^{ₜ}. Similarly, for any b∈{0,1}^{r}^{ₜ}, a vector x in L^{(b)} satisfies that every bit in Hx is b, and the vector x in A^{(b)} satisfies that the last bit in Hx is b, and therefore, L^{(b)}⊆A^{(b)}.

Next, it is proved that A⁽⁰⁾⊆L⁽⁰⁾∪(∪_{x∈L}⁽⁰⁾ Sₓ) and A⁽¹⁾⊆L⁽¹⁾∪(∪_{x∈L}_{⁽¹⁾}Sₓ).

For any y∈A⁽⁰⁾−L⁽⁰⁾, it is considered that t̅=Hy. Because t̅ satisfies t̅ₖ=0 and tₖ₋₁ . . . t₁≠0^{k-1},

$$1 \leq t \leq {\sum }_{i = 1}^{k - 1} {2}^{i - 1} < {2}^{k - 1} = {2}^{⌈ log ( {r}_{t} + 1 ) ⌉ - 1} < {2}^{log ( {r}_{t} + 1 )} = {r}_{t} + 1$$

Therefore 1≤t≤rₜ, and the following equation may be obtained by using Hₑ_{ₜ}=t̅:

H(y⊕eₜ)=Hy⊕Hₑ_{ₜ}=t̅⊕t̅=0^{k}

Therefore, y⊕eₜ∈L⁽⁰⁾.

That is, for any y∈A⁽⁰⁾−L⁽⁰⁾, there is x∈L⁽⁰⁾. For a specific integer t∈[rₜ], y=x⊕eₜ is satisfied. Therefore,

A⁽⁰⁾⊆L⁽⁰⁾∪(∪_{x∈L}_{⁽⁰⁾}_{,t∈[r}_{ₜ}_{]}{x⊕eₜ})=L⁽⁰⁾∪(∪_{x∈L}_{⁽⁰⁾}Sₓ)

For any y∈A⁽¹⁾−L⁽¹⁾, it is considered that t̅=Hy satisfies t̅ₖ=1 and tₖ₋₁ . . . t₁≠1^{k-1}. An order of value of the corresponding integer t may be out of a range of [rₜ]. To handle this case, t̅′̅=t̅⊕1^{k} is defined (and t′ is an integer corresponding to the vector t̅′̅). Now, t̅′̅ₖ=0 and t′ₖ₋₁ . . . t′₁≠0^{k-1} and therefore, t′∈[rₜ]. Therefore, He_{t′}=t′ may also be obtained, so as to obtain:

H(y⊕e_{t′})=Hy⊕He_{t′}=t̅⊕t̅′̅=t̅⊕t̅⊕1^{k}=1^{k}

Therefore, y⊕e_{t′}∈L⁽¹⁾, and

A⁽¹⁾⊆L⁽¹⁾∪(∪_{x∈L}_{⁽¹⁾}_{,t′∈[r}_{ₜ}_{]}{x⊕e_{t′}})=L⁽¹⁾∪(∪_{x∈L}_{⁽¹⁾}Sₓ)

L=L⁽⁰⁾∪L⁽¹⁾, then:

$${\{ 0 , 1 \}}^{{r}_{t}} = {A}^{( 0 )} ⋃ {A}^{( 1 )} ⊆ {L}^{( 0 )} ⋃ ( {⋃}_{x ∈ {L}^{( 0 )}} {S}_{x} ) ⋃ {L}^{( 1 )} ⋃ ( {⋃}_{x ∈ {L}^{( 1 )}} {S}_{x} ) = L ⋃ ( {⋃}_{x ∈ L} {S}_{x} ) ⊆ {\{ 0 , 1 \}}^{{r}_{t}}$$

The property of the matrix H is reviewed: over the finite field [symbol] ₂, rank(H)=k. Therefore, for any b∈{0,1}^{r}^{ₜ}, an order of values of a solution set L^{(b)} is

$$\vert {L}^{( b )} \vert \leq {2}^{{r}_{t} - k} \leq ⌈ \frac{{2}^{{r}_{t}}}{{r}_{t} + 1} ⌉ .$$

### Therefore,

$$\vert L \vert = \vert {L}^{( 0 )} \vert + \vert {L}^{( 1 )} \vert \leq 2 ⌈ \frac{{2}^{{r}_{t}}}{{r}_{t} + 1} ⌉ .$$

Because the set L is constructed, L satisfies that a value of the set is at most

$$2 ⌈ \frac{{2}^{{r}_{t}}}{{r}_{t} + 1} ⌉ ,$$

and L∪(∪_{x∈L} Sₓ) {0,1}^{r}^{ₜ}. Next, the set L is used to construct a set that satisfies the foregoing three properties.

Because 0^{k} is a solution of Hx=0^{k}, 0^{k} satisfies 0^{k}∈L⁽⁰⁾ ⊆L. Vectors in a set S₀_{^{k}}={e₁, e₂, . . . , eᵣ_{ₜ}} are linearly independent. For any x∈L and x≠0^{k}, two linearly independent sets of Boolean vectors Sₓ⁽⁰⁾ and Sₓ⁽¹⁾ are constructed. Because over the finite field [symbol] ₂, rank[x⊕e₁, x⊕e₂, . . . , x⊕eᵣ_{ₜ}]≥rₜ−1, rₜ−1 linearly independent vectors may be selected from Sₓ to form a set Sₓ⁽⁰⁾⊆Sₓ. Sₓ⁽¹⁾=(Sₓ−Sₓ⁽⁰⁾−{0^{r}^{ₜ}})∪{x}. It is not difficult to verify that if x=eⱼ is satisfied for a specific integer j∈[rₜ], then Sₓ⁽¹⁾={x}={eⱼ}; and if x∉{0ⁿ, e₁, e₂, . . . , eᵣ_{ₜ}}, then there is an integer j∈[rₜ], and Sₓ⁽¹⁾={x, x⊕eⱼ}. In either case, vectors in a set Sₓ⁽¹⁾ are linearly independent, and satisfy Sₓ⁽⁰⁾∪Sₓ⁽¹⁾=Sₓ∪{x}−{0^{r}^{ₜ}}. Therefore, for any b∈{0,1}, a set Sₓ^{(b)} may be extended to a linearly independent set Tₓ^{(b)} with a value of rₜ by adding a vector to the set Sₓ^{(b)}. L∪(∪_{x∈L} Sₓ) {0,1}^{r}^{ₜ} has been proved before, and therefore

$${\{ 0 , 1 \}}^{{r}_{t}} - \{ {0}^{{r}_{t}} \} = ( {⋃}_{x ∈ L} {S}_{x} ) ⋃ L - \{ {0}^{{r}_{t}} \} = {⋃}_{x ∈ L} ( {S}_{x} ⋃ \{ x \} ) - \{ {0}^{{r}_{t}} \} = ( {⋃}_{x ∈ L - \{ {0}^{{r}_{t}} \}} ( {S}_{x} ⋃ \{ x \} - \{ {0}^{{r}_{t}} \} ) ) = ( {⋃}_{x ∈ L - \{ {0}^{{r}_{t}} \}} ( {S}_{x}^{( 0 )} ⋃ {S}_{x}^{( 1 )} ) ) ⋃ {S}_{{0}^{{r}_{t}}} = ( {⋃}_{x ∈ L - \{ {0}^{{r}_{t}} \}} {S}_{x}^{( 0 )} ) ⊆ ( {⋃}_{x ∈ L - \{ {0}^{{r}_{t}} \}} {T}_{x}^{( 0 )} ) ⊆ {\{ 0 , 1 \}}^{{r}_{t}} - \{ {0}^{{r}_{t}} \}$$

A set {Tₓ⁽⁰⁾: x∈L∈{0^{r}^{ₜ}}} and a set {Tₓ⁽¹⁾: x∈L−{0^{r}^{ₜ}}} are combined with S₀rₜ as the constructed set T⁽¹⁾, T⁽²⁾, . . . ,

[symbol]

Because

$$\vert L \vert \leq 2 ⌈ \frac{{2}^{{r}_{t}}}{{r}_{t} + 1} ⌉$$

and 0^{r}^{ₜ}∈L, the total quantity of sets is [symbol] ≤2.

$$( 2 ⌈ \frac{{2}^{r} t}{{r}_{t} + 1} ⌉ - 1 ) + 1 = 4 ⌈ \frac{{2}^{r} t}{{r}_{t} + 1} ⌉ - 1.$$

Each set includes rₜ linearly independent vectors, and a union of all sets is exactly {0,1}^{r}^{ₜ}−{0^{r}^{ₜ}}.

The Gray path unitary operator is used for updating the quantum states of the n qubits based on the Gray code circle and bit string set F; and

bit strings included in the bit string set F use the bit strings in the bit string set T as a suffix, and use bit strings with a length of r_{c} and including elements 0 and 1 as a prefix, where

the bit string sets F respectively corresponding to the ⊇ unitary operators of the first type do not intersect with each other.

In the solution shown in this embodiment of this application, the quantum state of the qubit is updated through the Gray code circle, thereby implementing the quantum state preparation function in the quantum state preparation circuit.

The Gray path unitary operator includes 2^{r}^{_{c}}+1 stages;

a first stage in the 2^{r}^{_{c}}+1 stages is implemented by a first rotation gate; when a first bit string belongs to the bit string set F, the first rotation gate is used for executing a rotation operation corresponding to the first bit string on an i^{th} qubit in the last rₜ qubits; the first bit string is a bit string, for i∈[rₜ], using a bit string including an element 0 and with a length of r_{c} as a prefix, and using an i^{th} bit string in the bit string set T as a suffix;

a p^{th} stage in the 2^{r}^{_{c}}+1 stages is implemented by a first CNOT and a second rotation gate, and p∈{2, 3, . . . , 2^{r}^{_{c}}}; for i∈[rₜ], a control bit of the first CNOT is on a hᵢₚ^{th} qubit in the first r_{c} qubits, and a target bit of the first CNOT is on the i^{th} qubit in the last rₜ qubits; hᵢₚ is a bit sequence of different bit elements in a p−1^{th} bit string and a p^{th} bit string in the Gray code circle; when a second bit string belongs to the bit string set F, the second rotation gate is used for executing a rotation operation corresponding to the second bit string on an i^{th} qubit in the last rₜ qubits; the second bit string is a bit string using the p^{th} bit string in the Gray code circle as a prefix, and using the i^{th} bit string in the bit string set T as a suffix;

a last stage in the 2^{r}^{_{c}}+1 stages is implemented by a second CNOT; for i∈[rₜ], a control bit of the second CNOT is on a hᵢ₁^{th} qubit in the first r_{c} qubits, and a target bit of the second CNOT is on the i^{th} qubit in the last rₜ qubits; hᵢₚ is a bit sequence of different bit elements in a first bit string and a last bit string in the Gray code circle.

This embodiment of this application provides a specific solution for updating the quantum state of a qubit through a Gray code cycle, which ensures the implementability of the quantum state preparation through a quantum circuit with a low depth.

In this embodiment of this application, a depth of the Gray path unitary operator is O(2^{r}^{_{c}}), the depth of the Gray path unitary operator may be controlled, and then the depth of the quantum state preparation circuit is controlled.

In the Gray path stage, the operator U_{GrayPatg} is implemented, satisfying:

$$\vert {x}_{control} 〉 \vert {y}^{( k )} 〉 {\to }^{{U}_{G r a y P a t h}} {e}^{i {\sum }_{s ∈ {F}_{k}} 〈 s , x 〉 {α}_{s}} \vert {x}_{control} 〉 \vert {y}^{( k )} 〉 , \qquad ( 15. )$$

where k∈[ [symbol] ], and Fₖ is defined in equation (6).

For any i∈[rₜ], c₁ⁱ, c₂ⁱ, . . . , [symbol] is enabled to represent an i-Gray code cycle with a quantity of bits of r_{c}, and for any i∈[rₜ], c₁ⁱ=0^{r}^{_{c}}. Any j∈{2, 3, . . . , 2^{r}^{_{c}}} represents subscripts of different bits of cⱼ₋₁ⁱ and cⱼⁱ. hᵢ₁ is enabled to represent subscripts of different bits of c₁ⁱ and cⁱ₂r_{c}. For the i-Gray code cycle of r_{c} bits, hᵢⱼ is defined as follows:

$${h}_{i j} = \{ \begin{matrix}{r}_{c} , & i = j = 1 \\ i - 1 , & i ∈ \{ 2 , 3 , … , {r}_{t} \} and j = 1 \\ max \{ k : {2}^{k} \vert 2 ( j - 1 ) \} , & i = 1 and j ∈ \{ 2 , 3 , … , {2}^{{r}_{c}} \} \\ {h}_{1 j} + i - 1 , & if {h}_{1 j} + i - 1 \leq {r}_{c} and j ∈ \{ 2 , 3 , … , {2}^{{r}_{c}} \} \\ {h}_{1 j} + i - 1 - {r}_{c} , & if {h}_{1 j} + i - 1 > {r}_{c} and j ∈ \{ 2 , 3 , … , {2}^{{r}_{c}} \}\end{matrix} \qquad ( 16. )$$

The stage includes 2^{r}^{_{c}}+1 stages.

Stage 1 includes rotation gates. For any i∈[rₜ], if a bit string 0^{r}^{_{c}}tᵢ^{(k)}∈Fₖ, a circuit C₁ applies rotation

$$R ( {α}_{{0}^{r} {ct}_{i}^{( k )}} )$$

to the i^{th} bit of the target register, where

$${α}_{{0}^{r} {ct}_{i}^{( k )}}$$

is defined in equation (4).

In stage p∈{2, 3, . . . , 2^{r}^{_{c}}}, a circuit Cₚ includes two steps:

Step p.1 includes CNOT gates. For each i∈[rₜ], a control bit of the CNOT gate is in the hᵢₚ^{th} bit of the control register, and the target bit is in the i^{th} bit of the target register.

Step p.2 includes rotation gates. For each i∈[rₜ], if cₚⁱtᵢ^{(k)}∈Fₖ, then rotation

$$R ( {α}_{{c}_{p}^{i} {c}_{i}^{( k )}} )$$

is applied to the i^{th} bit of the target register.

Stage 2^{r}^{_{c}}+1 includes CNOT gates. For each i∈[rₜ], a control bit of the CNOT gate is in the hᵢ₁^{th} bit of the control register, and the target bit is in the i^{th} bit of the target register.

A depth of the circuit is O(2^{r}^{_{c}}) and the Gray path stage U_{GrayPath} (equation (15)) is implemented.

It is to be proven that for each p∈[2^{r}^{_{c}}], a set Fₖ^{(p)} is defined:

Fₖ^{(p)}{s: s∈Fₖ and s=cₚⁱtᵢ^{(k)}, i∈[rₜ]} (17.)

Defined by Fₖ in equation (6), the set Fₖ^{(p)} satisfies:

Fₖ⁽ⁱ⁾∪Fₖ^{(j)}=Ø, where i≠j∈[2^{r}^{_{c}}] (18.)

Fₖ=∪∩Fₖ^{(p)} (19.)

Next, how to implement the Gray path stage U_{GrayPath} by using C₁, C₂ . . . , [symbol] is verified step-by-step.

$$\vert {x}_{control} 〉 \vert {y}^{( k )} 〉 = \vert {x}_{control} 〉 \vert 〈 {0}^{{r}_{c}} {t}_{1}^{( k )} , x 〉 , 〈 {0}^{{r}_{c}} {t}_{2}^{( k )} , x 〉 , … , 〈 {0}^{{r}_{c}} {t}_{{r}_{t}}^{( k )} , x 〉 〉 = \vert {x}_{control} 〉 \vert {c}_{1}^{1} {t}_{1}^{( k )} , x \text{?} , 〈 {c}_{1}^{2} {t}_{2}^{( k )} , x \text{?} , … , 〈 {c}_{1}^{{r}_{t}} {t}_{{r}_{t}}^{( k )} , x \text{?} 〉$$

$${\to }^{{C}_{1}} \text{?} \vert {x}_{control} 〉 \vert 〈 {c}_{1}^{1} {t}_{1}^{( k )} , x \text{?} , 〈 {c}_{1}^{2} {t}_{2}^{( k )} , x \text{?} , … , 〈 {c}_{1}^{{r}_{t}} {t}_{{r}_{t}}^{( k )} , x \text{?} 〉$$

$${\to }^{{C}_{1}} \text{?} \vert {x}_{control} 〉 \vert 〈 {c}_{2}^{1} {t}_{1}^{( k )} , x \text{?} , 〈 {c}_{2}^{2} {t}_{2}^{( k )} , x \text{?} , … , 〈 {c}_{2}^{{r}_{t}} {t}_{{r}_{t}}^{( k )} , x \text{?} 〉$$

$${\to }^{{C}_{2} {r}_{c}} \text{?} \vert {x}_{control} 〉 \vert 〈 {c}_{{2}^{{r}_{c}}}^{1} {t}_{1}^{( k )} , x \text{?} , 〈 {c}_{{2}^{{r}_{c}}}^{2} {t}_{2}^{( k )} , x \text{?} , … , 〈 {c}_{{2}^{{r}_{c}}}^{{r}_{t}} {t}_{{r}_{t}}^{( k )} , x \text{?} 〉 = \text{?} \vert {x}_{control} 〉 \vert 〈 {c}_{{2}^{{r}_{c}}}^{1} {t}_{1}^{( k )} , x \text{?} , 〈 {c}_{{2}^{{r}_{c}}}^{2} {t}_{2}^{( k )} , x \text{?} , … , 〈 {c}_{{2}^{{r}_{c}}}^{{r}_{t}} {t}_{{r}_{t}}^{( k )} , x \text{?} 〉$$

$${\to }^{{C}_{2} {r}_{c + 1}} \text{?} \vert {x}_{control} 〉 \vert 〈 {c}_{1}^{1} {t}_{1}^{( k )} , x \text{?} , 〈 {c}_{1}^{2} {t}_{2}^{( k )} , x \text{?} , … , 〈 {c}_{1}^{{r}_{t}} {t}_{{r}_{t}}^{( k )} , x \text{?} 〉 = \text{?} \vert {x}_{control} 〉 \vert {y}^{( k )} 〉$$

$$\text{?} \text{indicates text missing or illegible when filed}$$

A circuit depth of the circuit is analyzed below. Stage 1 includes rotation gates that are applied on different bits in the target register, and therefore, the rotation gates may be implemented in one layer of circuit. In each stage p∈{2, 3, . . . , 2^{r}^{_{c}}}, because cₚ₋₁ⁱ and cₚⁱ differ by only one bit, only one CNOT gate needs to be constructed [symbol] cₚⁱtᵢ^{(k)}, x [symbol] from a function [symbol] cₚ₋₁ⁱtᵢ^{(k)}, x [symbol] . A control bit of the CNOT gate is in the hᵢₚ^{th} qubit of the control register, and a target bit is in the i^{th} qubit of the target register. It may be learnt from equation (16), subscripts h₁ₚ, h₂ₚ, . . . , hᵣ_{ₜ}ₚ of the control bits are all different. Therefore, the CNOT gate in step p.1 may be implemented in one layer of circuit. The rotation gate in step p.2 may be applied in different qubits, and therefore may also be implemented in one layer of circuit. Similarly, stage 2^{r}^{_{c}}+1 may also be implemented in one layer of circuit. Therefore, a total circuit depth in the Gray path stage is at most 1+2·(2^{r}^{_{c}}-1)+1=2·2^{r}^{_{c}}.

Therefore, a depth of the operator [symbol] ₖ is O(2^{r}^{_{c}})+O(rₜ/log rₜ)=O(2^{r}^{_{c}}).

Step 406. Replace the N qubit uniform control gates with the diagonal unitary matrix and the single bit gate that are obtained in a recursive manner, to obtain the quantum state preparation circuit.

In this application, the n qubits corresponding to the diagonal unitary matrix are divided into the first r_{c} qubits and the last rₜ qubits. Then, the diagonal unitary matrix is transformed into the unitary operator of the first type, the unitary operator of the second type, and the diagonal unitary matrix corresponding to the first r_{c} qubits based on the division result. The diagonal unitary matrix obtained by the transformation is continued to be transformed in a recursive manner, so as to achieve the effect of reducing the depth of the quantum state preparation circuit.

An idea of recursion is used in this application, a quantum circuit of a diagonal unitary matrix Λₙ with no auxiliary bit is designed, and a depth is O(2ⁿ/n). A quantum state preparation circuit with a depth of O(2^{N}/N) is obtained from the circuit. A lower bound of a depth of the quantum state preparation circuit with no auxiliary bit is Ω(2^{N}/N). Therefore, the circuit depth of this application is the optimal depth in the progressive sense.

As an important process, the quantum state preparation widely exists in various quantum algorithms. By improving the circuit depth of quantum state preparation circuit, the circuit depth of quantum algorithms such as a quantum machine learning algorithm, a physical system simulation algorithm, and a quantum linear system solving algorithm may be effectively reduced.

In summary, in the solution shown in this embodiment of this application, based on a quantum state intermediate preparation circuit including N qubit uniform control gates, each of the qubit uniform control gates is respectively converted into a diagonal unitary matrix and a single bit gate. Through the unitary operator of the first type and the unitary operator of the second type, the diagonal unitary matrix is implemented in a recursive manner, thereby reducing a depth of the quantum state preparation circuit.

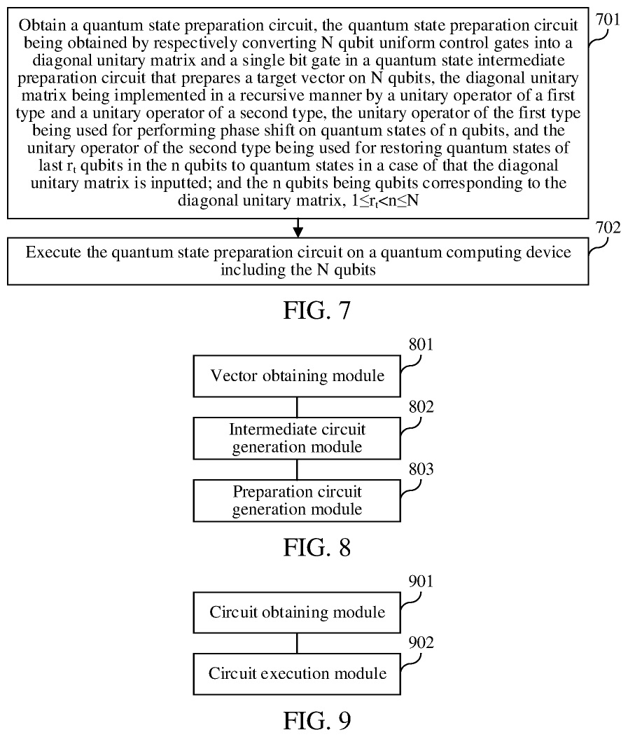

FIG. 7 is a flowchart of a quantum state preparation method according to an embodiment of this application. An execution entity of each step of the method may be a computer device or a quantum computer. The method may include the following steps:

Step 701. Obtain a quantum state preparation circuit, the quantum state preparation circuit being obtained by respectively converting N qubit uniform control gates into a diagonal unitary matrix and a single bit gate in a quantum state intermediate preparation circuit that prepares a target vector on N qubits, the diagonal unitary matrix being implemented in a recursive manner by a unitary operator of a first type and a unitary operator of a second type, the unitary operator of the first type being used for performing phase shift on quantum states of n qubits, and the unitary operator of the second type being used for restoring quantum states of last rₜ qubits in the n qubits to quantum states in a case of that the diagonal unitary matrix is inputted; and the n qubits being qubits corresponding to the diagonal unitary matrix, 1≤rₜ≤n≤N, and rₜ and n are integers.

Step 702. Execute the quantum state preparation circuit on a quantum computing device including the N qubits.

For a generation process of the quantum state preparation circuit, reference may be made to a solution in the embodiment shown in FIG. 2 or FIG. 4, which is not repeated herein.

In summary, in the solution shown in this embodiment of this application, based on a quantum state intermediate preparation circuit including N qubit uniform control gates, each of the qubit uniform control gates is respectively converted into a diagonal unitary matrix and a single bit gate. Through the unitary operator of the first type and the unitary operator of the second type, the diagonal unitary matrix is implemented in a recursive manner, and a quantum state preparation circuit with a circuit depth close to a lower bound of a theoretical depth can be constructed, thereby reducing a depth of the quantum state preparation circuit.

FIG. 8 is a block diagram of a quantum state preparation circuit generation apparatus according to an embodiment of this application. The apparatus has a function of implementing an example of the quantum state preparation circuit generation method. As shown in FIG. 8, the apparatus may include:

a vector obtaining module 801, configured to obtain a target vector;

an intermediate circuit generation module 802, configured to generate a quantum state intermediate preparation circuit for preparing the target vector on N qubits, the quantum state intermediate preparation circuit including N qubit uniform control gates, and N being a positive integer greater than or equal to 2; and

a preparation circuit generation module 803, configured to respectively convert the N qubit uniform control gates into a diagonal unitary matrix and a single bit gate, to obtain a quantum state preparation circuit for preparing the target vector on the N qubits,

the diagonal unitary matrix being implemented in a recursive manner by a unitary operator of a first type and a unitary operator of a second type; the unitary operator of the first type being used for performing phase shift on quantum states of n qubits, and the unitary operator of the second type being used for restoring quantum states of last rₜ qubits in the n qubits to quantum states when the diagonal unitary matrix is inputted; and the n qubits being qubits corresponding to the diagonal unitary matrix, 1≤rₜ<n≤N, and rₜ and n being integers.

In an example implementation, the preparation circuit generation module 803 is configured to:

divide n qubits corresponding to a target diagonal unitary matrix into first r_{c} qubits and last rₜ qubits, where a value of r_{c} is ┌n/2┐, and a value of rₜ is └n/2┘; and the target diagonal unitary matrix is a qubit diagonal unitary matrix obtained by decomposing any one of the qubit uniform control gates;

convert the target diagonal unitary matrix into [symbol] unitary operators of the first type, a unitary operator of the second type, and a first diagonal unitary matrix corresponding to the first r_{c} qubits, where

$$ℓ \leq 4 ⌈ \frac{{2}^{{r}_{t}}}{{r}_{t} + 1} ⌉ - 1 ,$$

and [symbol] is an integer;

convert, in a recursive manner, the first diagonal unitary matrix as a new target diagonal unitary matrix into unitary operators of the first type, unitary operators of the second type, and a new first diagonal unitary matrix; and

replace the N qubit uniform control gates with the diagonal unitary matrix and the single bit gate that are obtained in a recursive manner, to obtain the quantum state preparation circuit.

In an example implementation, the unitary operator of the first type includes a generated unitary operator and a Gray path unitary operator;

the generated unitary operator is used for converting a computing base into invertible linear transformation over a finite field on the last rₜ qubits; and

the Gray path unitary operator is used for implementing the phase shift on the quantum states of the n qubits through a Gray code circle whose quantity of bits is r_{c}.

In an example implementation, the generated unitary operator is used for updating the quantum states of the last rₜ qubits by bit string set T; and

the bit string set T includes bit strings with a length of rₜ and including elements 0 and 1, and the bit strings included in the bit string set T are linearly independent.

In an example implementation, the generated unitary operator is implemented by a controlled-NOT gate CNOT.

In an example implementation, a depth of the generated unitary operator is O(rₜ/log rₜ).

In an example implementation, the Gray path unitary operator is used for updating the quantum states of the n qubits based on the Gray code circle and bit string set F; and

bit strings included in the bit string set F use the bit strings in the bit string set T as a suffix, and use bit strings with a length of r_{c} and including elements 0 and 1 as a prefix, where

the bit string sets F respectively corresponding to the [symbol] unitary operators of the first type do not intersect with each other.

In an example implementation, the Gray path unitary operator includes 2^{r}^{_{c}}+1 stages;

a first stage in the 2^{r}^{_{c}}+1 stages is implemented by a first rotation gate; when a first bit string belongs to the bit string set F, the first rotation gate is used for executing a rotation operation corresponding to the first bit string on an i^{th} qubit in the last rₜ qubits; the first bit string is a bit string, for i∈[rₜ], using a bit string including an element 0 and with a length of r_{c} as a prefix, and using an i^{th} bit string in the bit string set T as a suffix;

a p^{th} stage in the 2^{r}^{_{c}}+1 stages is implemented by a first CNOT and a second rotation gate, and p∈{2, 3, . . . , 2^{r}^{_{c}}}; for i∈[rₜ], a control bit of the first CNOT is on a hᵢₚ^{th} qubit in the first r_{c} qubits, and a target bit of the first CNOT is on the i^{th} qubit in the last rₜ qubits; hᵢₚ is a bit sequence of different bit elements in a p−1^{th} bit string and a p^{th} bit string in the Gray code circle; when a second bit string belongs to the bit string set F, the second rotation gate is used for executing a rotation operation corresponding to the second bit string on the i^{th} qubit in the last rₜ qubits; the second bit string is a bit string using the p^{th} bit string in the Gray code circle as a prefix, and using the i^{th} bit string in the bit string set T as a suffix;

a last stage in the 2^{r}^{_{c}}+1 stages is implemented by a second CNOT; for i∈[rₜ], a control bit of the second CNOT is on a hᵢ₁^{th} qubit in the first r_{c} qubits, and a target bit of the second CNOT is on the i^{th} qubit in the last rₜ qubits; and hᵢₚ is a bit sequence of different bit elements in a first bit string and a last bit string in the Gray code circle.

In an example implementation, a depth of the Gray path unitary operator is Q(2^{r}^{_{c}}).

In an example implementation, the unitary operator of the second type is implemented by a CNOT with a depth of O(rₜ/log rₜ).

In summary, in the solution shown in this embodiment of this application, based on a quantum state intermediate preparation circuit including N qubit uniform control gates, each of the qubit uniform control gates is respectively converted into a diagonal unitary matrix and a single bit gate. Through the unitary operator of the first type and the unitary operator of the second type, the diagonal unitary matrix is implemented in a recursive manner, and a quantum state preparation circuit with a circuit depth close to a lower bound of a theoretical depth can be constructed, thereby reducing a depth of the quantum state preparation circuit.

FIG. 9 is a block diagram of a quantum state preparation apparatus according to an embodiment of this application. The apparatus has a function of implementing an example of the quantum state preparation method. As shown in FIG. 9, the apparatus may include:

a circuit obtaining module 901, configured to obtain a quantum state preparation circuit, the quantum state preparation circuit being obtained by respectively converting N qubit uniform control gates into a diagonal unitary matrix and a single bit gate in a quantum state intermediate preparation circuit that prepares a target vector on N qubits, the diagonal unitary matrix being implemented in a recursive manner by a unitary operator of a first type and a unitary operator of a second type, the unitary operator of the first type being used for performing phase shift on quantum states of n qubits, and the unitary operator of the second type being used for restoring quantum states of last rₜ qubits in the n qubits to quantum states when the diagonal unitary matrix is inputted, the n qubits being qubits corresponding to the diagonal unitary matrix, 1≤rₜ<n≤N, and rₜ and n being integers; and

a circuit execution module 902, configured to execute the quantum state preparation circuit on a quantum computing device including the N qubits.

In the disclosure above, a unit or a module may be hardware such as a combination of electronic circuitries, firmware, or software such as computer instructions. The unit and the module may also be any combination of hardware, firmware, and software. In some implementation, a unit may include at least one module.

In summary, in the solution shown in this embodiment of this application, based on a quantum state intermediate preparation circuit including N qubit uniform control gates, each of the qubit uniform control gates is respectively converted into a diagonal unitary matrix and a single bit gate. Through the unitary operator of the first type and the unitary operator of the second type, the diagonal unitary matrix is implemented in a recursive manner, and a quantum state preparation circuit with a circuit depth close to a lower bound of a theoretical depth can be constructed, thereby reducing a depth of the quantum state preparation circuit.

When the apparatus provided in the foregoing embodiments implements functions of the apparatus, it is illustrated with an example of division of each functional module. In the practical application, the function distribution may be finished by different functional modules according to the requirements, that is, the internal structure of the device is divided into different functional modules, to implement all or some of the functions described above. In addition, the apparatus and method embodiments provided in the foregoing embodiments belong to one conception. For the specific implementation process, refer to the method embodiments, and details are not described herein again.

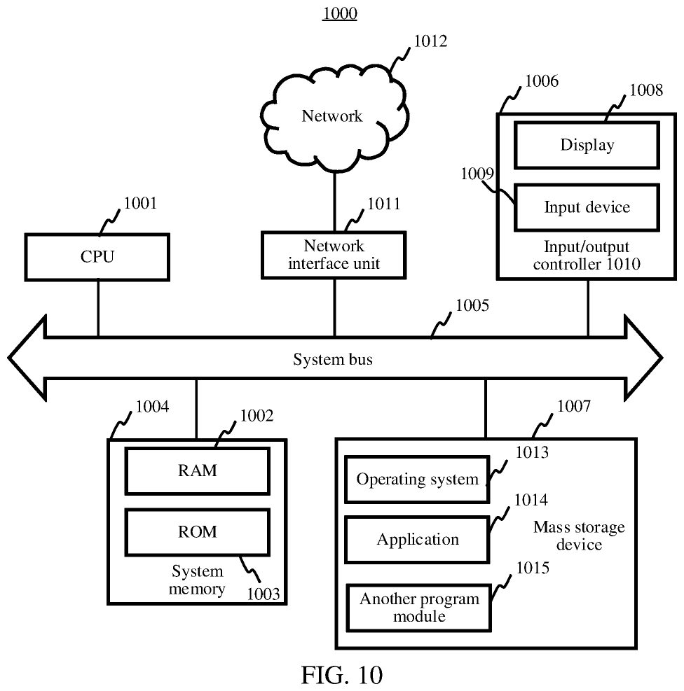

FIG. 10 is a structural block diagram of a computer device according to an embodiment of this application. The computer device may be configured to implement the method provided in the foregoing embodiments. For example, the computer device is a classic computer:

the computer device 1000 includes a central processing unit (CPU), a graphics processing unit (GPU), and a field programmable gate array (FPGA) 1001, including a system memory 1004 of a random access memory (RAM) 1002 and a read only memory (ROM) 1003, and a system bus 1005 connecting the system memory 1004 and the CPU 1001. The computer device 1000 further includes a basic input/output system (I/O system) 1006 configured to transmit information between components in the server, and a mass storage device 1007 configured to store an operating system 1013, an application program 1014, and another program module 1015.

The basic I/O system 1006 includes a display 1008 configured to display information and an input device 1009 such as a mouse or a keyboard that is used for inputting information by a user. The display 1008 and the input device 1009 are both connected to the CPU 1001 by using an input/output controller 1010 connected to the system bus 1005. The basic I/O system 1006 may further include the input/output controller 1010 to receive and process inputs from a plurality of other devices such as a keyboard, a mouse, and an electronic stylus. Similarly, the input/output controller 1010 further provides an output to a display screen, a printer or another type of output device.

The mass storage device 1007 is connected to the CPU 1001 by using a mass storage controller (not shown) connected to the system bus 1005. The mass storage device 1007 and a computer-readable medium associated with the large-capacity storage device provide non-volatile storage to the computer device 1000. That is, the mass storage device 1007 may include a computer-readable medium (not shown) such as a hard disk or a compact disc read-only memory (CD-ROM) drive.

In general, the computer-readable medium may include a computer storage medium and a communication medium. The computer storage medium includes volatile and non-volatile media, and removable and non-removable media implemented by using any method or technology and configured to store information such as a computer-readable instruction, a data structure, a program module, or other data. The computer storage medium includes a RAM, a ROM, an erasable programmable ROM (EPROM), an electrically erasable programmable ROM (EEPROM), a flash memory or another solid-state memory technology, a CD-ROM, a digital versatile disc (DVD) or another optical memory, a tape cartridge, a magnetic cassette, a magnetic disk memory, or another magnetic storage device. Certainly, a person skilled in the art may know that the computer storage medium is not limited to the foregoing types. The system memory 1004 and the mass storage device 1007 may be collectively referred to as a memory.

According to the embodiments of this application, the computer device 1000 may further be connected, through a network such as the Internet, to a remote computer on the network and run. That is, the computer device 1000 may be connected to a network 1012 by using a network interface unit 1011 connected to the system bus 1005, or may be connected to another type of network or a remote computer system (not shown) by using a network interface unit 1011.

The memory further includes at least one computer instruction, the at least one computer instruction being stored in the memory, and being configured to be executed by one or more processors to implement the quantum state preparation circuit generation method or the quantum state preparation method as described above.

In an exemplary embodiment, a computer-readable storage medium is further provided, storing at least one computer instruction, the at least one computer instruction being executed by a processor to implement the quantum state preparation circuit generation method or the quantum state preparation method as described above.

In some example implementations, the computer-readable storage medium may include: a read-only memory (ROM), a random-access memory (RAM), a solid-state drive (SSD), an optical disc, or the like. The RAM may include a resistance random access memory (ReRAM) and a dynamic random access memory (DRAM).

In an exemplary embodiment, a computer program product or a computer program is further provided. The computer program product or the computer program includes computer instructions, and the computer instructions are stored in a computer-readable storage medium. A processor of a computer device reads the computer instruction from the computer-readable storage medium, and the processor executes the computer instruction, to cause the computer device to perform the method according to the foregoing embodiments.

In an exemplary embodiment, a quantum operation chip is further provided, and the quantum operation chip is used in a computer device to implement the method according to the foregoing embodiments.

In an exemplary embodiment, a quantum computer is further provided. The quantum computer is configured to implement the method according to the foregoing embodiments.

It is to be understood that “plurality of” mentioned in the specification means two or more. “And/or” describes an association relationship for describing associated objects and represents that three relationships may exist. For example, A and/or B may represent the following three cases: only A exists, both A and B exist, and only B exists. The character “/” in this specification generally indicates an “or” relationship between the associated objects. In addition, the step numbers described in this specification merely exemplarily show a possible execution sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not limited in the embodiments of this application.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A quantum state preparation circuit generation method, performed by a computer device, the method comprising:
obtaining a target vector;
generating a quantum state intermediate preparation circuit for preparing the target vector on N qubits, the quantum state intermediate preparation circuit comprising N qubit uniform control gates, and N being a positive integer greater than or equal to 2; and
converting each of the N qubit uniform control gates into a diagonal unitary matrix and a single bit gate to obtain a quantum state preparation circuit for preparing the target vector on the N qubits by:
implementing the diagonal unitary matrix in a recursive manner using a unitary operator of a first type and a unitary operator of a second type, the unitary operator of the first type being configured to perform phase shift on quantum states of n qubits, and the unitary operator of the second type being configured to restore quantum states of last rₜ qubits in the n qubits to quantum states when the diagonal unitary matrix is inputted, wherein 1≤rₜ<n≤N, and rₜ and n are integers.

2. The method according to claim 1, wherein converting each of the N qubit uniform control gates into the diagonal unitary matrix and the single bit gate to obtain the quantum state preparation circuit for preparing the target vector on the N qubits comprises:
dividing the n qubits corresponding to a target diagonal unitary matrix into first r_{c} qubits and the last rₜ qubits, wherein a value of r_{c} is ┌n/2┐, and a value of rₜ is └n/2┘, and wherein the target diagonal unitary matrix is a diagonal unitary matrix obtained by decomposing any one of the N qubit uniform control gates;
converting the target diagonal unitary matrix into [symbol] unitary operators of the first type, a unitary operator of the second type, and a first diagonal unitary matrix corresponding to the first r_{c} qubits, wherein
$$ℓ \leq 4 ⌈ \frac{{2}^{{r}_{t}}}{{r}_{t} + 1} ⌉ - 1 ,$$
and [symbol] is an integer;
converting, in a recursive manner, the first diagonal unitary matrix as a new target diagonal unitary matrix into unitary operators of the first type, unitary operators of the second type, and a new first diagonal unitary matrix; and
replacing the N qubit uniform control gates with the diagonal unitary matrix and the single bit gate that are obtained in a recursive manner, to obtain the quantum state preparation circuit.

3. The method according to claim 2, wherein:
the unitary operator of the first type comprises a base-conversion unitary operator and a Gray path unitary operator;
the base-conversion unitary operator is configured to convert a computing base into invertible linear transformation over a finite field on the last rₜ qubits; and
the Gray path unitary operator is configured to implement the phase shift on the quantum states of the n qubits through a Gray code circle whose quantity of bits is r_{c}.

4. The method according to claim 3, wherein:
the base-conversion unitary operator is configured to update the quantum states of the last rₜ qubits through a bit string set T; and
the bit string set T comprises bit strings with a length of rₜ and comprising elements 0 and 1, and the bit strings comprised in the bit string set T being linearly independent.

5. The method according to claim 3, wherein the base-conversion unitary operator comprises a controlled-NOT (CNOT) gate.

6. The method according to claim 3, wherein a depth of the base-conversion unitary operator is O(rₜ/log rₜ).

7. The method according to claim 4, wherein:
the Gray path unitary operator is configured to update the quantum states of the n qubits based on the Gray code circle and a bit string set F;
bit strings in the bit string set F comprise the bit strings in the bit string set T as a suffix, and a prefix comprising bit strings with a length of r_{c} and comprising elements 0 and 1; and
the bit string set F corresponding to the [symbol] unitary operators of the first type do not intersect with each other.

8. The method according to claim 7, wherein:
the Gray path unitary operator comprises 2^{r}^{_{c}}+1 stages;
a first stage in the 2^{r}^{_{c}}+1 stages comprises a first rotation gate;
when a first bit string belongs to the bit string set F:
the first rotation gate is configured to execute a rotation operation corresponding to the first bit string on an i^{th} qubit in the last rₜ qubits;
the first bit string, for i∈[rₜ], comprises a prefix containing an element 0 and with a length of r_{c}, and a suffix containing an i^{th} bit string in the bit string set T;
a p^{th} stage in the 2^{r}^{_{c}}+1 stages comprises a first CNOT and a second rotation gate, and p∈{2, 3, . . . , 2^{r}^{_{c}}};
for i∈[rₜ], a control bit of the first CNOT is provided by a hᵢₚ^{th} qubit in the first r_{c} qubits, and a target bit of the first CNOT is provided by the i^{th} qubit in the last rₜ qubits; and
hᵢₚ comprises different bit elements in a p−1^{th} bit string and a p^{th} bit string in the Gray code circle; and
when a second bit string belongs to the bit string set F:
the second rotation gate is configured to execute a rotation operation corresponding to the second bit string on the i^{th} qubit in the last rₜ qubits;
the second bit string comprises a prefix containing the p^{th} bit string in the Gray code circle, and a suffix containing s the i^{th} bit string in the bit string set T;
a second CNOT is configured to implement a last stage in the 2^{r}^{_{c}}+1 stages;
for i∈[rₜ], a control bit of the second CNOT is provided by a hᵢ₁^{th} bit in the first r_{c} qubits, and a target bit of the second CNOT is provided by the i^{th} qubit in the last rₜ qubits; and
hᵢₚ comprises different bit elements in a first bit string and a last bit string in the Gray code circle.

9. The method according to claim 3, wherein a depth of the Gray path unitary operator is O(2^{r}^{_{c}}).

10. The method according to claim 2, wherein the unitary operator of the second type is implemented by a CNOT with a depth of O(rₜ/log rₜ).

11. A quantum state preparation method, performed by a computer device or a quantum computer, the method comprising:
obtaining a quantum state preparation circuit by converting N qubit uniform control gates into a diagonal unitary matrix and a single bit gate in a quantum state intermediate preparation circuit that prepares a target vector on N qubits, and implementing the diagonal unitary matrix in a recursive manner busing a unitary operator of a first type and a unitary operator of a second type, the unitary operator of the first type being configured to perform phase shift on quantum states of n qubits, the unitary operator of the second type being configured to restore quantum states of last rₜ qubits in the n qubits to quantum states when the diagonal unitary matrix is inputted, wherein 1≤rₜ<n≤N, and rₜ and n are integers; and
executing the quantum state preparation circuit on a quantum computing device comprising the N qubits.

12. A quantum state preparation circuit generation apparatus, comprising a circuitry configured to:
obtain a target vector;
generate a quantum state intermediate preparation circuit for preparing the target vector on N qubits, the quantum state intermediate preparation circuit comprising N qubit uniform control gates, and N being a positive integer greater than or equal to 2; and
convert the N qubit uniform control gates into a diagonal unitary matrix and a single bit gate, to obtain a quantum state preparation circuit for preparing the target vector on the N qubits by:
implementing the diagonal unitary matrix in a recursive manner using a unitary operator of a first type and a unitary operator of a second type, the unitary operator of the first type being configured to perform phase shift on quantum states of n qubits, the unitary operator of the second type being configured to restore quantum states of last rₜ qubits in the n qubits to quantum states when the diagonal unitary matrix is inputted, wherein 1≤rₜ<n≤N, and rₜ and n are integers.

13. The apparatus according to claim 12, wherein the circuitry is configured to:
divide the n qubits corresponding to a target diagonal unitary matrix into first r_{c} qubits and last rₜ qubits, wherein a value of r_{c} is ┌n/2 ┐, and a value of rₜ is └n/2 ┘; and wherein the target diagonal unitary matrix is a qubit diagonal unitary matrix obtained by decomposing any one of the N qubit uniform control gates;
convert the target diagonal unitary matrix into [symbol] unitary operators of the first type, a unitary operator of the second type, and a first diagonal unitary matrix corresponding to the first r_{c} qubits, wherein
$$ℓ \leq 4 ⌈ \frac{{2}^{{r}_{t}}}{{r}_{t} + 1} ⌉ - 1 ,$$
and [symbol] is an integer;
convert in a recursive manner, the first diagonal unitary matrix as a new target diagonal unitary matrix into unitary operators of the first type, unitary operators of the second type, and a new first diagonal unitary matrix; and
replace the N qubit uniform control gates with the diagonal unitary matrix and the single bit gate that are obtained in a recursive manner, to obtain the quantum state preparation circuit.

14. The apparatus according to claim 13, wherein the unitary operator of the first type comprises a base-conversion unitary operator and a Gray path unitary operator;
the base-conversion unitary operator is configured to convert a computing base into invertible linear transformation over a finite field on the last rₜ qubits; and
the Gray path unitary operator is configured to implement the phase shift on the quantum states of the n qubits through a Gray code circle whose quantity of bits is r_{c}.

15. The apparatus according to claim 14, wherein the base-conversion unitary operator is configured to update the quantum states of the last rₜ qubits through a bit string set T; and
the bit string set T comprises bit strings with a length of rₜ and comprising elements 0 and 1, and the bit strings comprised in the bit string set T being linearly independent.

16. The apparatus according to claim 14, wherein the base-conversion unitary operator comprises a controlled-NOT (CNOT) gate.

17. The apparatus according to claim 14, wherein a depth of the base-conversion unitary operator is O(rₜ/log rₜ).

18. The apparatus according to claim 15, wherein
the Gray path unitary operator is configured to update the quantum states of the n qubits based on the Gray code circle and a bit string set F;
bit strings comprised in the bit string set F comprise the bit strings in the bit string set T as a suffix, and a prefix comprising bit strings with a length of r_{c} and comprising elements 0 and 1 as a prefix; and
the bit string set F corresponding to the [symbol] unitary operators of the first type do not intersect with each other.

19. The apparatus according to claim 18, wherein:
the Gray path unitary operator comprises 2^{r}^{_{c}}+1 stages;
a first stage in the 2^{r}^{_{c}}+1 stages comprises a first rotation gate;
when a first bit string belongs to the bit string set F:
the first rotation gate is configured to execute a rotation operation corresponding to the first bit string on an i^{th} qubit in the last rₜ qubits;
the first bit string, for i∈[rₜ], comprises a prefix containing an element 0 and with a length of r_{c} as a prefix, and a suffix containing an i^{th} bit string in the bit string set T;
a p^{th} stage in the 2^{r}^{_{c}}+1 stages comprises a first CNOT and a second rotation gate, and p∈{2, 3, . . . , 2^{r}^{_{c}}};
for i∈[rₜ], a control bit of the first CNOT is provided by a hᵢₚ^{th} qubit in the first r_{c} qubits, and a target bit of the first CNOT is provided by the i^{th} qubit in the last rₜ qubits; and
hᵢₚ comprises different bit elements in a p−1^{th} bit string and a p^{th} bit string in the Gray code circle; and
when a second bit string belongs to the bit string set F:
the second rotation gate is configured to execute a rotation operation corresponding to the second bit string on the i^{th} qubit in the last rₜ qubits;
the second bit string comprises a prefix containing the p^{th} bit string in the Gray code circle, and a suffix containing the i^{th} bit string in the bit string set T;
a second CNOT is configured to implement a last stage in the 2^{r}^{_{c}}+1 stages;
for i∈[rₜ], a control bit of the second CNOT is provided by a hᵢ₁^{th} bit in the first r_{c} qubits, and a target bit of the second CNOT is provided by the i^{th} qubit in the last rₜ qubits; and
hᵢₚ comprises different bit elements in a first bit string and a last bit string in the Gray code circle.

20. The apparatus according to claim 14, wherein a depth of the Gray path unitary operator is O(2^{r}^{_{c}}).
